(19) United States
(12) Patent Application Publication
(10) Pub. No.: US 2021/0053441 A1
(43) Pub. Date: Feb. 25, 2021

(54) DISPLAY CONTROL APPARATUS, DISPLAY CONTROL METHOD, AND PROGRAM

(71) Applicant: HONDA MOTOR CO., LTD., Tokyo (JP)

(72) Inventor: Shuichi Kazuno, Wako-shi (JP)

(21) Appl. No.: 16/992,151

(22) Filed: Aug. 13, 2020

(30) Foreign Application Priority Data
Aug. 20, 2019 (JP) 2019-150339

(51) Int. Cl. B60K 35/00; B60L 58/12; B60L 58/16

(52) U.S. Cl. CPC B60K 35/00; B60L 58/12; B60L 58/16; B60K 2370/1876; B60K 2370/165; B60K 2370/174; B60K 2370/155

(57) ABSTRACT

A display control apparatus includes: an acquisition part that acquires usage situation information of a battery which stores electric power for traveling of a vehicle; an evaluation part that evaluates a degree of degradation of the battery based on the usage situation information acquired by the acquisition part; and a display control part that allows a display part to display an image indicating a flow of energy in the vehicle, wherein the display control part allows the display part to display the image based on an evaluation result of the evaluation part.

### CROSS-REFERENCE TO RELATED APPLICATION

Priority is claimed on Japanese Patent Application No. 2019-150339, filed on Aug. 20, 2019, the contents of which are incorporated herein by reference.

### BACKGROUND

### Field of the Invention

The present invention relates to a display control apparatus, a display control method, and a program.

### Background

In the related art, techniques have been disclosed in which a diagnostic result of in-vehicle consumables is presented to a vehicle user (for example, refer to Japanese Unexamined Patent Application, First Publication No. 2005-227141).

### SUMMARY

A user of a vehicle such as a EV (Electric Vehicle) or a PEV (Plug-in Hybrid Vehicle) on which a battery is mounted may not be aware of the degradation of the battery, and that the performance of the battery is deteriorated compared to that at a start time of usage. Therefore, it is preferable that a user be informed of such degradation of the battery, and that the performance of the battery is degraded. However, in the related art, it is difficult to inform a user that the battery is degraded in a visually easy-to-understand manner.

An object of an aspect of the present invention is to provide a display control apparatus, a display control method, and a program capable of informing a user that a battery is degraded in a visually easy-to-understand manner.

A display control apparatus according to a first aspect of the present invention includes: an acquisition part that acquires usage situation information of a battery which stores electric power for traveling of a vehicle; an evaluation part that evaluates a degree of degradation of the battery based on the usage situation information acquired by the acquisition part; and a display control part that allows a display part to display an image indicating a flow of energy in the vehicle, wherein the display control part allows the display part to display the image based on an evaluation result of the evaluation part.

A second aspect of the present invention is a display control apparatus according to the first aspect, wherein the evaluation part may further evaluate a degree of degradation of the future battery based on the usage situation information, and the display control part may allow the display part to display the image based on an evaluation result of the future battery evaluated by the evaluation part.

A third aspect of the present invention is a display control apparatus according to the first or second aspect, wherein the display control part may allow the display part to display the image in a situation in which a behavior of the vehicle is affected by the degradation of the battery.

A display control method according to a fourth aspect of the present invention includes: by way of a computer, acquiring usage situation information of a battery which stores electric power for traveling of a vehicle; evaluating a degree of degradation of the battery based on the acquired usage situation information; displaying, on a display part, an image indicating a flow of energy in the vehicle; and displaying, on the display part, the image based on an evaluation result.

A fifth aspect of the present invention is a computer-readable non-transitory storage medium that includes a program causing a computer to: acquire usage situation information of a battery which stores electric power for traveling of a vehicle; evaluate a degree of degradation of the battery based on the acquired usage situation information; display, on a display part, an image indicating a flow of energy in the vehicle; and display, on the display part, the image based on an evaluation result.

According to the first to fifth aspects described above, it is possible to inform a user that the battery is degraded in a visually easy-to-understand manner.

According to the second aspect described above, it is possible to inform a user of the estimated degradation of the future battery in a visually easy-to-understand manner.

According to the third aspect described above, it is possible to inform a user of the degradation of the battery in a visually easy-to-understand manner at a timing when the output of the vehicle is affected and decreased by the degradation of the battery.

### BRIEF DESCRIPTION OF THE DRAWINGS

FIG. 1 is a view showing an example of a configuration of a vehicle on which a display control apparatus is mounted.

FIG. 2 is a view showing an example of a functional configuration of a control part.

FIG. 3 is a view showing the switching of a travel mode.

FIG. 4 is a view showing an example of a pattern of a deceleration control mainly performed in the vehicle.

FIG. 5 is a view showing an example of a pattern of a deceleration control mainly performed in the vehicle.

FIG. 6 is a view showing an example of a configuration of a display control apparatus.

FIG. 7 is a view showing an example of an attachment position of a display part.

FIG. 8A is a view showing an example of an energy flow image IMEF-1 which can be displayed when the vehicle is stopping.

FIG. 8B is a view showing an example of an energy flow image IMEF-2 which can be displayed when the vehicle is stopping.

FIG. 8C is a view showing an example of an energy flow image IMEF-3 which can be displayed when the vehicle is stopping.

FIG. 9 is a view showing an example of an energy flow image IMEF-4 displayed when the vehicle travels in an EV travel mode.

FIG. 10A is a view showing an example of an energy flow image IMEF-5 displayed when the vehicle travels in a series hybrid travel mode.

FIG. 10B is a view showing an example of an energy flow image IMEF-6 displayed when the vehicle travels in the series hybrid travel mode.

FIG. 10C is a view showing an example of an energy flow image IMEF-7 displayed when the vehicle travels in the series hybrid travel mode.

FIG. 11A is a view showing an example of an energy flow image IMEF-8 displayed when the vehicle travels in an engine drive travel mode.

FIG. 11B is a view showing an example of an energy flow image IMEF-9 displayed when the vehicle travels in the engine drive travel mode.

FIG. 11C is a view showing an example of an energy flow image IMEF-10 displayed when the vehicle travels in the engine drive travel mode.

FIG. 12A is a view showing an example of an energy flow image IMEF-11 displayed when the vehicle decelerates according to regeneration.

FIG. 12B is a view showing an example of an energy flow image IMEF-12 displayed when the vehicle decelerates according to regeneration.

FIG. 13 is a view showing an example of contents of degradation image information.

FIG. 14 is a view showing an example of an energy flow image IMEF-4 when the degree of degradation of a battery is “bad”.

FIG. 15 is a view showing another example of an energy flow image IMEF-4 when the degree of degradation of the battery is “bad”.

FIG. 16 is a flowchart showing an example of a process of the display control apparatus according to an embodiment.

FIG. 17 is a flowchart showing an example of a process of the display control apparatus according to modified example 1.

FIG. 18A is a view showing an example of an energy flow image IMEF-4 according to modified example 2.

FIG. 18B is a view showing an example of an energy flow image IMEF-4 according to modified example 2.

FIG. 19 is a view showing an example of an energy flow image IMEF-4 when high-efficiency driving is performed.

FIG. 20 is a view showing an example of a configuration of a vehicle that includes a display control apparatus according to a second embodiment.

FIG. 21 is a view showing an example of a configuration of a FC system according to the second embodiment.

### DESCRIPTION OF THE EMBODIMENTS

Hereinafter, embodiments of a display control apparatus, a display control method, and a program of the present invention will be described with reference to the drawings.

[Overall Configuration]

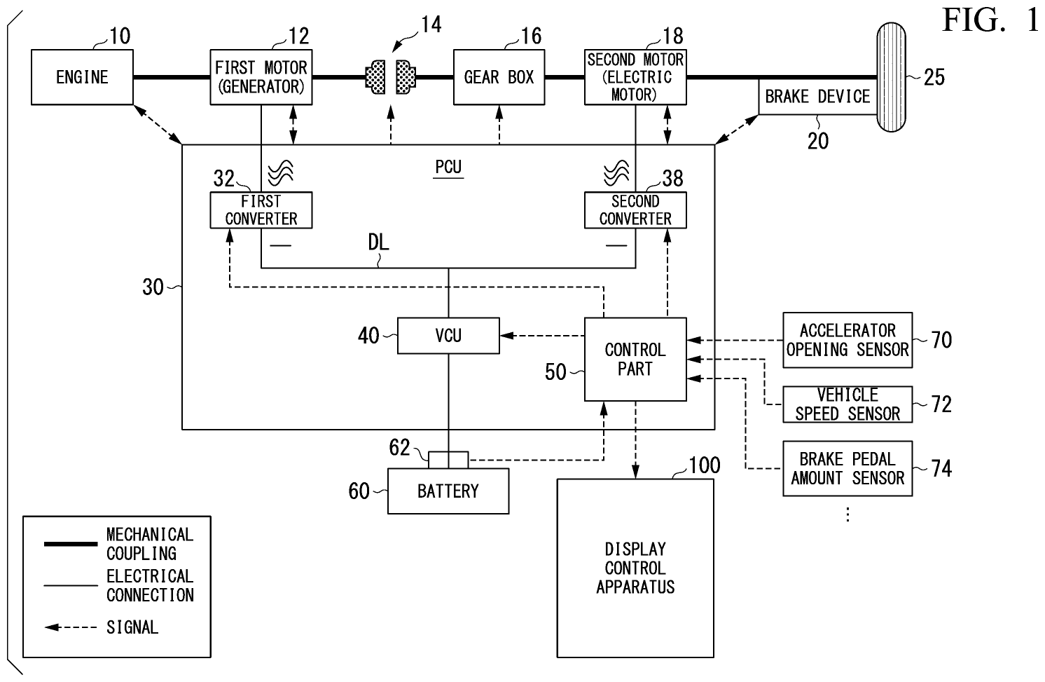

FIG. 1 is a view showing an example of a configuration of a vehicle on which a display control apparatus 100 according to a first embodiment is mounted. The vehicle having the configuration shown in FIG. 1 is a hybrid vehicle capable of switching a series method and a parallel method. The series method is a method in which an engine and a drive wheel are not mechanically connected, the power of the engine is exclusively used for electric power generation by a generator, and generated electric power is supplied to an electric motor for traveling. The parallel method is a method in which an engine and a drive wheel can be mechanically (or via a fluid such as a torque converter) connected, and power of the engine can be transmitted to the drive wheel or can be used for electric power generation. The vehicle having the configuration shown in FIG. 1 is able to switch between the series method and the parallel method by connecting or disconnecting a lock-up clutch 14. The configuration is not limited thereto, and the display control apparatus 100 can be mounted on a hybrid vehicle using the series method or can be mounted on a hybrid vehicle using the parallel method. The vehicle may be a vehicle in which a battery can be charged by plug-in charging.

As shown in FIG. 1, the vehicle includes, for example, an engine 10, a first motor (generator) 12, the lock-up clutch 14, a gear box 16, a second motor (electric motor) 18, a brake device 20, a drive wheel 25, a PCU (Power Control Unit) 30, a battery 60, a battery sensor 62 such as a voltage sensor, a current sensor, and a temperature sensor, a vehicle sensor such as an accelerator opening sensor 70, a vehicle speed sensor 72, and a brake pedal amount sensor 74, and a display control apparatus 100 which are mounted on the vehicle. The vehicle includes at least the engine 10, the second motor 18, and the battery 60 as a drive source.

The engine 10 is an internal combustion engine that outputs power by burning a fuel such as gasoline. The engine 10 is a reciprocating engine that includes, for example, a cylinder, a piston, an intake valve, an exhaust valve, a fuel injection device, a spark plug, a connection rod, a crankshaft, and the like. The engine 10 may be a rotary engine.

The first motor 12 is, for example, a three-phase alternating current generator. The first motor 12 has a rotor connected to an output shaft (for example, a crankshaft) of the engine 10 and generates electric power using power output by the engine 10. The output shaft of the engine 10 and a rotor of the first motor 12 are connected to a side of the drive wheel 25 via the lock-up clutch 14.

In response to a command from the PCU 30, the lock-up clutch 14 switches between a state (hereinafter, referred to as a connected state) in which the output shaft of the engine 10 and the rotor of the first motor 12 are connected to the side of the drive wheel 25 and a state (hereinafter, referred to as a separated state) in which the output shaft of the engine 10 and the rotor of the first motor 12 are disconnected from the side of the drive wheel 25.

The gear box 16 is a transmission. The gear box 16 changes a speed of the power output by the engine 10 and transmits the power to the side of the drive wheel 25. A gear ratio of the gear box 16 is designated by the PCU 30.

The second motor 18 is, for example, a three-phase alternating current electric motor. A rotor of the second motor 18 is connected to the drive wheel 25. The second motor 18 outputs power to the drive wheel 25 using supplied electric power. The second motor 18 generates electric power using kinetic energy of the vehicle at the time of deceleration of the vehicle. In the following description, an electric power generation operation by the second motor 18 may be referred to as regeneration in some cases.

The brake device 20 includes, for example, a brake caliper, a cylinder that transmits a hydraulic pressure to the brake caliper, and an electric motor that generates the hydraulic pressure in the cylinder. The brake device 20 may include, as a backup, a mechanism that transmits a hydraulic pressure generated by an operation of a brake pedal to the cylinder via a master cylinder. The brake device 20 is not limited to the configuration described above and may be an electronically controlled hydraulic pressure brake device that transmits a hydraulic pressure of the master cylinder to the cylinder.

The PCU 30 includes, for example, a first converter 32, a second converter 38, a VCU (Voltage Control Unit) 40, and a control part 50. The integrated configuration of these configuration elements as the PCU 30 is merely an example, and these configuration elements may be arranged in a distributed manner.

The first converter 32 and the second converter 38 are, for example, an AC-DC converter. Direct current side terminals of the first converter 32 and the second converter 38 are connected to a DC link DL. The battery 60 is connected to the DC link DL via the VCU 40. The first converter 32 converts an alternating current generated by the first motor 12 into a direct current and outputs the direct current to the DC link DL or converts a direct current supplied via the DC link DL into an alternating current and supplies the alternating current to the first motor 12. Similarly, the second converter 38 converts an alternating current generated by the second motor 18 into a direct current and outputs the direct current to the DC link DL or converts a direct current supplied via the DC link DL into an alternating current and supplies the alternating current to the second motor 18.

The VCU 40 is, for example, a DC-DC converter. The VCU 40 increases a voltage of an electric power supplied from the battery 60 and outputs the electric power to the DC link DL.

Functions of the control part 50 will be described below. The battery 60 is, for example, a secondary battery such as a lithium-ion battery.

The accelerator opening sensor 70 is attached to an accelerator pedal, which is an example of an operator that receives an acceleration command by a driver. The accelerator opening sensor 70 detects an operation amount of the accelerator pedal and outputs the detected operation amount of the accelerator pedal to the control part 50 as an accelerator opening. The vehicle speed sensor 72 includes, for example, a wheel speed sensor attached to each wheel and a speed calculator. The vehicle speed sensor 72 derives a speed (a vehicle speed) of the vehicle by integrating wheel speeds detected by the wheel speed sensor and outputs the derived vehicle speed to the control part 50. The brake pedal amount sensor 74 is attached to a brake pedal, which is an example of an operator that receives a deceleration or stop command by a driver. The brake pedal amount sensor 74 detects an operation amount of the brake pedal and outputs the detected operation amount of the brake pedal to the control part 50 as a brake pedal amount.

The display control apparatus 100 will be described after the control part 50.

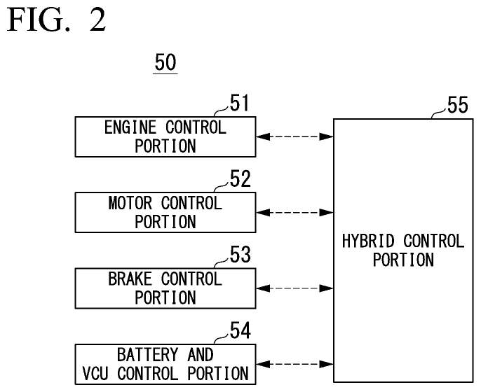

FIG. 2 is a view showing an example of a functional configuration of the control part 50. The control part 50 includes, for example, an engine control portion 51, a motor control portion 52, a brake control portion 53, a battery and VCU control portion 54, and a hybrid control portion 55. These configuration elements are realized, for example, by a hardware processor such as a CPU (Central Processing Unit) executing a program (software). Some or all of these configuration elements may be realized by hardware (a circuit section; including circuitry) such as a LSI (Large-Scale Integration), an ASIC (Application-Specific Integrated Circuit), a FPGA (Field-Programmable Gate Array), and a GPU (Graphics-Processing Unit) or may be realized by cooperation of software and hardware.

Each of the engine control portion 51, the motor control portion 52, the brake control portion 53, and the battery and VCU control portion 54 may be replaced by a control device separated from the hybrid control portion 55, that is, for example, a control device such as an engine ECU (Electronic Control Unit), a motor ECU, a brake ECU, and a battery ECU.

The engine control portion 51 performs an ignition control, a throttle opening control, a fuel injection control, a fuel cut control, and the like of the engine 10 in accordance with a command from the hybrid control portion 55. The engine control portion 51 may calculate an engine rotation frequency on the basis of an output of a crank angle sensor attached to the crankshaft and output the calculated engine rotation frequency to the hybrid control portion 55.

The motor control portion 52 performs a switching control of the first converter 32 and/or the second converter 38 in accordance with a command from the hybrid control portion 55.

The brake control portion 53 controls the brake device 20 in accordance with a command from the hybrid control portion 55.

The battery and VCU control portion 54 calculates a SOC (State Of Charge; a charging rate) of the battery 60 on the basis of an output of the battery sensor 62 attached to the battery 60 and outputs the calculated SOC to the hybrid control portion 55. The battery and VCU control portion 54 causes the VCU 40 to operate in accordance with a command from the hybrid control portion 55 and raises a voltage of the DC link DL.

The hybrid control portion 55 determines a travel mode on the basis of outputs of the accelerator opening sensor 70, the vehicle speed sensor 72, and the brake pedal amount sensor 74 and outputs commands to the engine control portion 51, the motor control portion 52, the brake control portion 53, and the battery and VCU control portion 54 in accordance with a travel mode.

[Various Types of Travel Mode]

Hereinafter, a travel mode determined by the hybrid control portion 55 will be described. The travel mode includes the following modes.

(1) EV Travel Mode (EV)

In an EV travel mode, the hybrid control portion 55 brings the lock-up clutch 14 into a separated state, drives the second motor 18 using electric power supplied from the battery 60, and causes the vehicle to travel according to power from the second motor 18.

(2) Series Hybrid Travel Mode (ECVT)

In a series hybrid travel mode, the hybrid control portion 55 brings the lock-up clutch 14 into the separated state, supplies a fuel to the engine 10 to operate the engine 10, and supplies electric power generated by the first motor 12 to the battery 60 and the second motor 18. Then, the second motor 18 is driven using electric power supplied from the first motor 12 or the battery 60, and the vehicle is caused to travel using power from the second motor 18.

(3) Engine Drive Travel Mode (LU)

In an engine drive travel mode, the hybrid control portion 55 brings the lock-up clutch 14 into the connected state, causes the engine 10 to consume the fuel and operate, and transmits at least part of the power output by the engine 10 to the drive wheel 25 to cause the vehicle to travel. At this time, the first motor 12 may perform or may not perform electric power generation. When the power that is output by the engine 10 is insufficient, the second motor 18 may output or may not output an amount of power that supplies the shortfall to the drive wheel 25. The engine drive travel mode is a mode that realizes a parallel method. The engine drive travel mode is employed when the speed of the vehicle is within a predetermined range in which the engine 10 has good operation efficiency.

(4) Regeneration

At the time of regeneration, the hybrid control portion 55 brings the lock-up clutch 14 into the separated state and causes the second motor 18 to perform electric power generation using the kinetic energy of the vehicle. The generated electric power at the time of regeneration is stored in the battery 60 or discarded by an electric power discard operation.

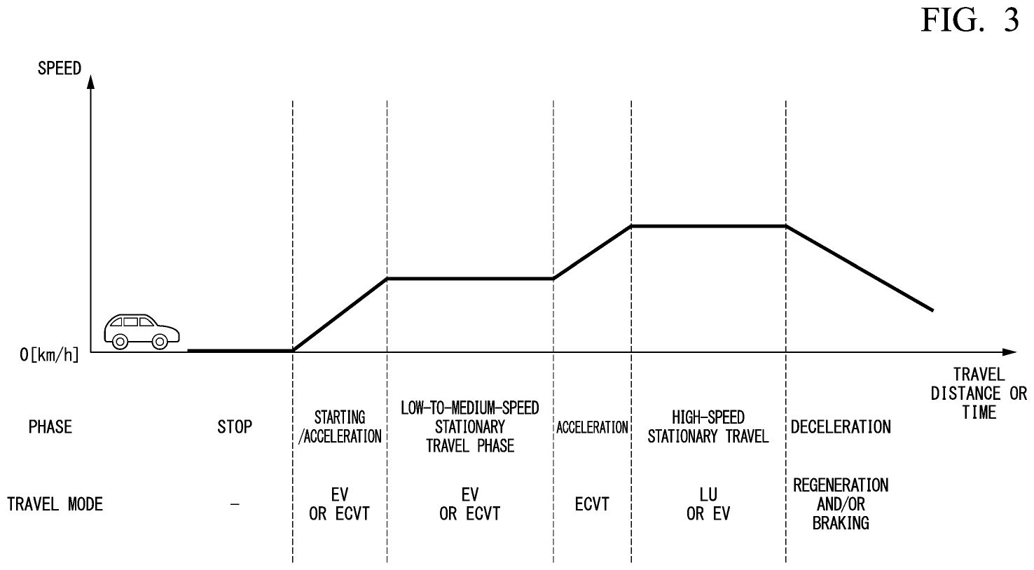

FIG. 3 is a view showing the switching of the travel mode. In the drawing, the vertical axis represents a speed, and the horizontal axis represents a travel distance or time.

In a starting/acceleration phase, the hybrid control portion 55 causes the vehicle to start, for example, in the EV travel mode and then switches between the EV travel mode and the series hybrid travel mode in accordance with the SOC of the battery 60.

In a low-to-medium-speed stationary travel phase, the hybrid control portion 55 switches, for example, between the EV travel mode and the series hybrid travel mode in accordance with the SOC of the battery 60. At this time, with reference to map data and a position of the vehicle, when the vehicle travels in an urban area, the low noise EV travel mode may be adopted or the like.

In the acceleration phase, the hybrid control portion 55 causes the vehicle to travel, for example, in the series hybrid travel mode. In the acceleration phase and a subsequent high-speed stationary travel phase, the hybrid control portion 55 improves the output performance of the second motor 18 by causing the VCU 40 to operate and raising the voltage of the DC link DL.

In the high-speed stationary travel phase, the hybrid control portion 55 switches, for example, between the engine drive travel mode and the EV travel mode. The engine drive travel mode is, for example, a travel mode adopted within a speed range (for example, 60 [km/h] to 100 [km/h]) in which the engine 10 can efficiently operate. At a speed exceeding this range, the EV travel mode is adopted in a state where the VCU 40 is operated and the voltage of the DC link DL is raised.

In a deceleration phase, the hybrid control portion 55 performs, for example, one or both of braking by regeneration and braking by the brake device 20.

[Deceleration Control]

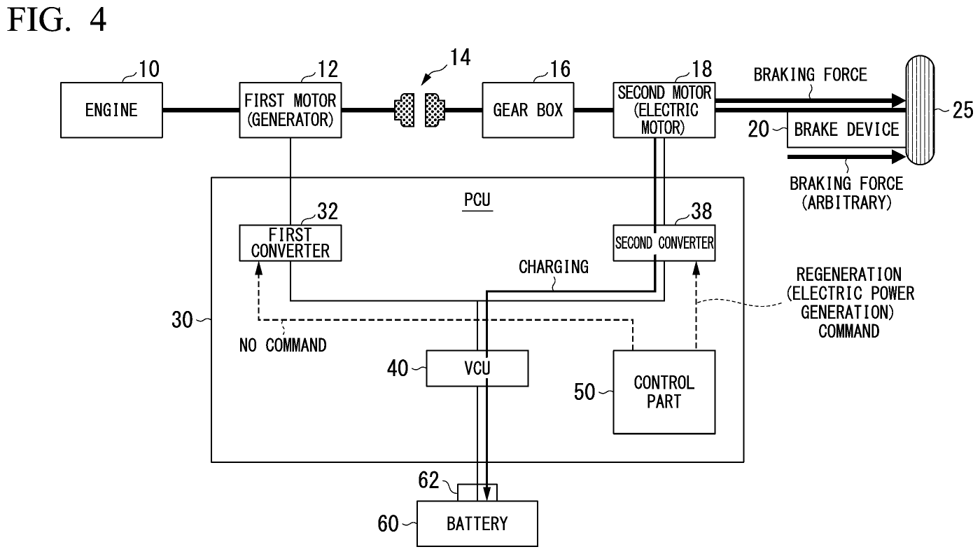

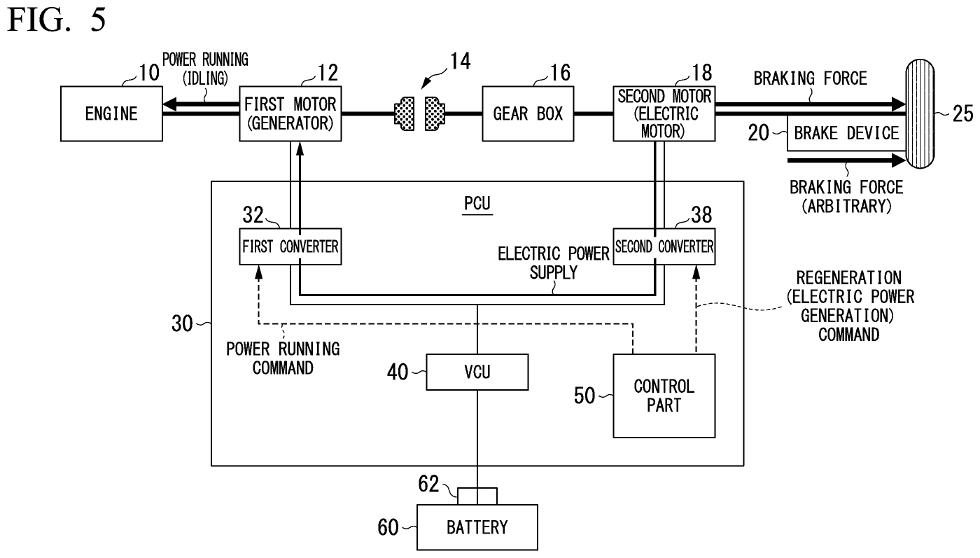

Here, a deceleration control in the vehicle will be described. FIGS. 4 and 5 are views showing an example of a pattern of the deceleration control mainly performed in the vehicle. In the deceleration control shown in FIG. 4, the second motor 18 outputs a braking force to the drive wheel 25 while performing electric power generation by regeneration, and the electric power generated by the second motor 18 is stored in the battery 60. The lock-up clutch 14 is kept in the separated state. At this time, a braking force may be output to the drive wheel 25 also by the brake device 20. The control part 50 outputs a command for causing the second motor 18 to perform regeneration to the second converter 38 and does not output a command to the first converter 32. Hereinafter, the deceleration control shown in FIG. 4 may be referred to as regeneration (charging) in some cases.

In the deceleration control shown in FIG. 5, the second motor 18 outputs a braking force to the drive wheel 25 while performing electric power generation by regeneration, and electric power generated by the second motor 18 is supplied to the first motor 12. The first motor 12 idles the engine 10 using the supplied electric power. The lock-up clutch 14 is kept in the separated state. At this time, a braking force may be output to the drive wheel 25 also by the brake device 20. The control part 50 outputs a command for causing the second motor 18 to perform regeneration to the second converter 38 and outputs a command for causing the first motor 12 to idle the engine 10 to the first converter 32. A fuel cut control is performed on the engine 10. Hereinafter, the deceleration control shown in FIG. 5 may be referred to as regeneration (electric power discard) in some cases. The regeneration (electric power discard) is performed when the SOC of the battery 60 is sufficiently high and further charging is neither required nor preferred.

In addition to the control shown in FIG. 4 or FIG. 5, a control that decelerates the vehicle by only the brake device 20 may be performed.

[Display Control Apparatus]

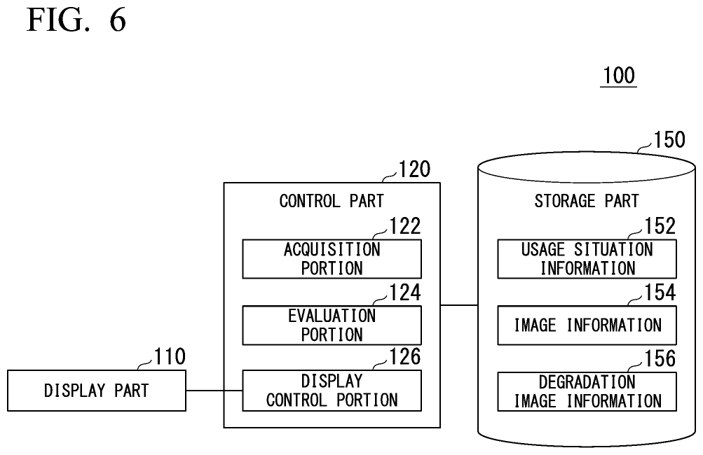

Hereinafter, a display control apparatus 100 will be described. FIG. 6 is a view showing an example of a configuration of the display control apparatus 100. The display control apparatus 100 includes, for example, a display part 110, a control part 120, and a storage part 150. The display part 110 is realized by a LCD (Liquid Crystal Display), an organic EL (Electroluminescence) display control device, a HUD (Head Up Display), or the like.

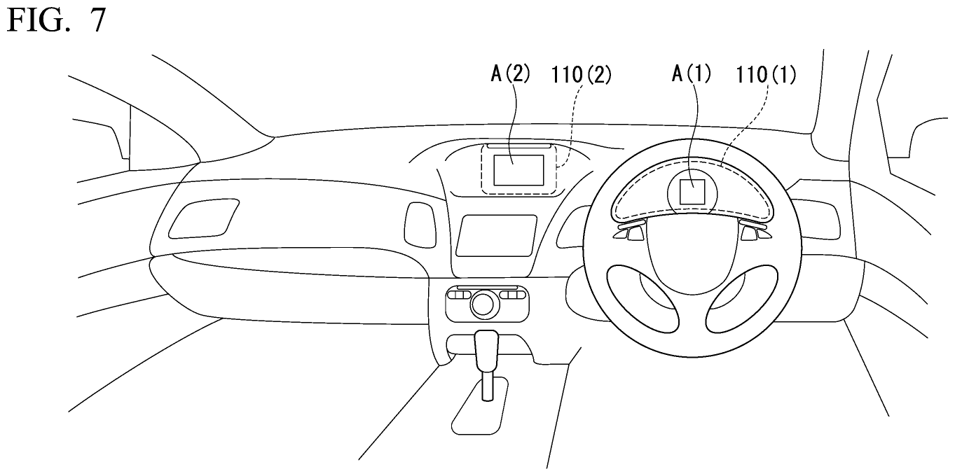

FIG. 7 is a view showing an example of an attachment position of the display part 110. As shown in FIG. 7, the display part 110 may be a device (110(1) in the drawing) provided in a portion of an instrument panel facing a driver to perform a display including a speedometer and may be a device (110(2) in the drawing) provided near a vehicle central axis of the instrument panel to display a navigation image and the like. In the former case, the display part 110 displays an energy flow image IMEF described below, for example, in an area A (1) in the speedometer. In the latter case, the display part 110 displays the energy flow image IMEF in an arbitrary area A (2). An attachment position of the display part 110 is not limited to that of the example shown in FIG. 7 and may be an arbitrary position.

With reference back to FIG. 6, the control part 120 includes an acquisition portion 122, an evaluation portion 124, and a display control portion 126. The control part 120 is realized, for example, by a hardware processor such as a CPU executing a program (software). The control part 120 may be realized by hardware (a circuit section; including circuitry) such as the LSI, ASIC, FPGA, and GPU or may be realized by cooperation of software and hardware.

The program may be stored in advance in a storage device (non-transitory storage medium) such as a HDD (Hard Disk Drive) or a flash memory such as the storage part 150 or may be stored in a detachable storage medium (non-transitory storage medium) such as a DVD or a CD-ROM and installed by the storage medium being mounted on a drive device. The storage part 150 stores, for example, information such as usage situation information 152, image information 154, and degradation image information 156 in addition to the program. Details of the above various types of information will be described below.

The acquisition portion 122 acquires, for example, information (for example, the SOC of the battery 60) regarding the battery 60 calculated by the control part 50 and information indicating a detection result of the battery 60 detected by the battery sensor 62 from the control part 50 continuously or at a predetermined time interval. The acquisition portion 122 estimates the degree of degradation of the battery 60 on the basis of the acquired information. The acquisition portion 122 derives, for example, a current full-charge capacity (hereinafter, referred to as a “current maximum capacity”) of the battery 60. The acquisition portion 122 derives a maximum capacity ratio of the current maximum capacity to an initial maximum capacity on the basis of the current maximum capacity and the initial maximum capacity. The maximum capacity ratio is an example of information indicating the degree of degradation of the battery 60. The initial maximum capacity is a full-charge capacity (or a rated full-charge capacity of the battery 60) of the battery 60 at the time of shipping.

The above embodiment is described using a case in which the acquisition portion 122 estimates the degree of degradation of the battery 60; however, the embodiment is not limited thereto. For example, the control part 50 may estimate the degree of degradation of the battery 60, and the acquisition portion 122 may acquire information indicating an estimation result of the control part 50.

The acquisition portion 122 generates (updates) the usage situation information 152 on the basis of the acquired information and the derived information. The usage situation information 152 is, for example, information including one or more records in which information indicating the degree of degradation of the battery 60, information indicating the SOC of the battery 60, information indicating a detection result of the battery 60 detected by the battery sensor 62, and the like and information indicating the date and time of acquisition when these information are acquired (or detected) are associated with each other. The acquisition portion 122 generates a record of the usage situation information 152 and generates (updates) the usage situation information 152 on the basis of the acquired information.

The evaluation portion 124 evaluates a degradation amount of the battery 60 on the basis of the usage situation information 152.

The evaluation portion 124 extracts, for example, records in an evaluation target period (for example, from the time of shipping of the battery 60 until now) of the usage situation information 152. Then, the evaluation portion 124 compares a current maximum capacity of the newest record with a current maximum capacity of the oldest record among the extracted records and derives a degradation amount at which the battery 60 degrades in the evaluation target period. The degradation amount is, for example, a capacity obtained by subtracting the current maximum capacity of the newest record from the current maximum capacity of the oldest record.

The display control portion 126 causes the display part 110 to display an energy flow image IMEF indicating a flow of energy in the vehicle. On the basis of the degradation amount derived by the evaluation portion 124, the image information 154, and the degradation image information 156, the display control portion 126 changes an image included in the energy flow image IMEF depending on the degradation amount. The image information 154 is information indicating an image (an icon or the like described below) that is not changed depending on the degradation amount among configuration elements (images) that constitute the energy flow image IMEF. The degradation image information 156 is information indicating an image (a flow object or the like described below) that is changed depending on the degradation amount among the configuration elements (images) that constitute the energy flow image IMEF. First, a process in which the display control portion 126 causes the display part 110 to display the energy flow image IMEF will be described. Next, a process in which the display control portion 126 changes the image included in the energy flow image IMEF depending on the degradation amount will be described.

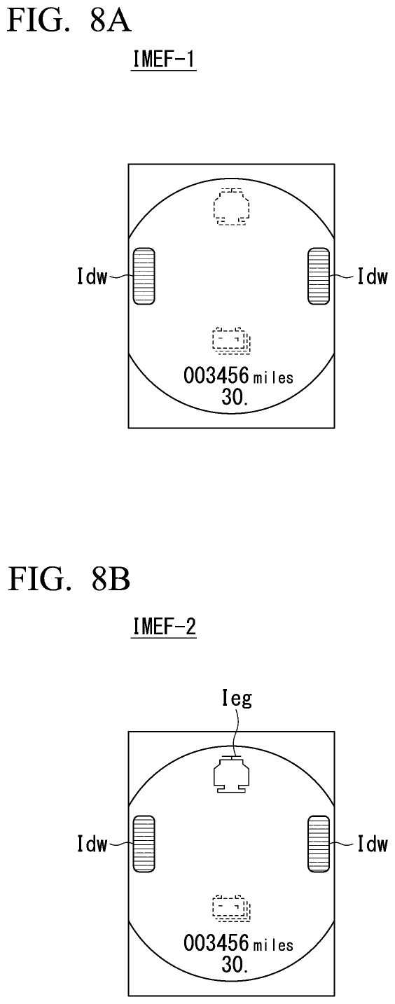

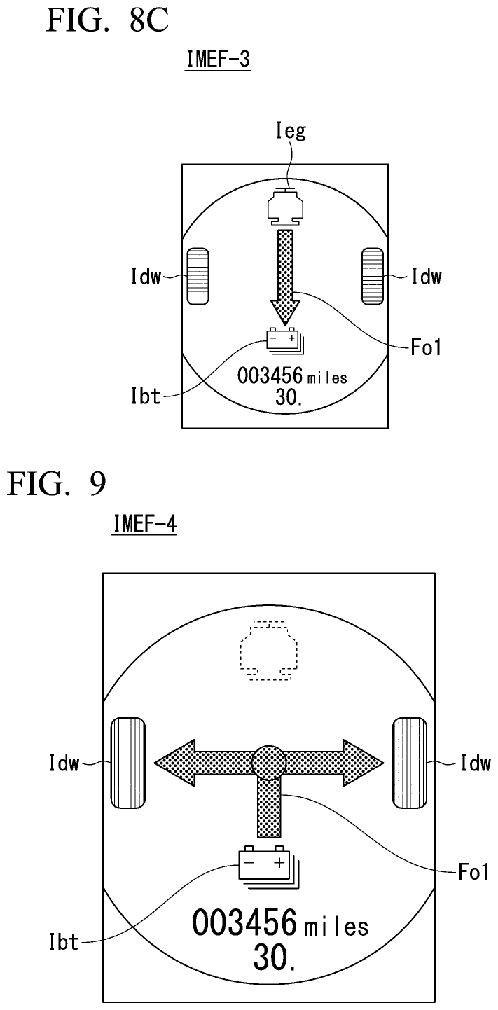

FIG. 8A to FIG. 12B are views showing an example of a mode of the energy flow image IMEF. Configuration elements of the energy flow image IMEF include, for example, an icon Ieg indicating that the engine 10 operates, an icon Ibt indicating that the battery 60 is charged or discharged, an icon Idw indicating a drive wheel, and a flow object Fo indicating a flow of energy by animation, an arrow, or the like. The icon Ieg and the icon Ibt indicate whether or not the engine 10 operates or whether or not the battery 60 is charged or discharged by switching between a display state and a non-display state. The non-display state may be replaced by a “display reduced state” in which coloring or luminance is reduced to be more inconspicuous than the display state, but the display reduced state will be described as a state included in the non-display state in the following description. The icon Ieg in the display state is an example of a “predetermined image.” The icon Idw indicating the drive wheel may be displayed all the time regardless of the state of the vehicle.

FIG. 8A to 8C are views showing examples of energy flow images IMEF-1 to IMEF-3 which can be displayed when the vehicle is stopping. FIG. 8A shows an energy flow image IMEF-1 displayed when the vehicle is stopping and the engine 10 is inactive. In the energy flow image IMEF-1, both the icon Ieg and the icon Ibt are in the non-display state, and the flow object Fo is also not displayed.

FIG. 8B shows an energy flow image IMEF-2 displayed when neither the first motor 12 nor the second motor 18 performs electric power generation although the vehicle is stopping and the engine 10 operates. The icon Ieg is displayed in the energy flow image IMEF-2.

FIG. 8C shows an energy flow image IMEF-3 displayed when the vehicle is stopping, the engine 10 operates, and the first motor 12 performs electric power generation. The icon Ieg and the icon Ibt are displayed, and further a flow object Fo directed toward the icon Ibt from the icon Ieg is displayed in the energy flow image IMEF-3.

FIG. 9 is a view showing an example of an energy flow image IMEF-4 displayed when the vehicle travels in the EV travel mode. The icon Ibt is displayed, and further a flow object Fo1 directed toward the icon Idw from the icon Ibt is displayed in the energy flow image IMEF-4.

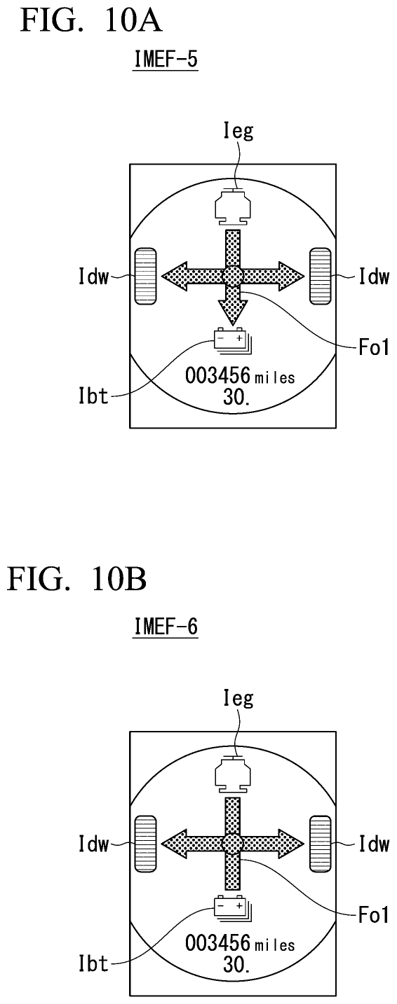

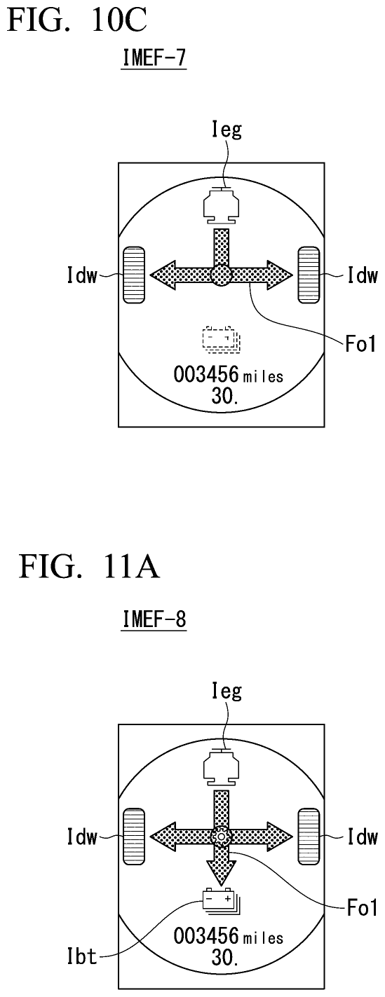

FIG. 10A to 10C are views showing examples of energy flow images IMEF-5 to IMEF-7 displayed when the vehicle travels in the series hybrid travel mode. FIG. 10A shows an energy flow image IMEF-5 displayed when the vehicle travels in the series hybrid travel mode and the battery 60 is charged. In the energy flow image IMEF-5, the icon Ieg and the icon Ibt are displayed, and the flow object Fo1 directed toward the icon Ibt and the icon Idw from the icon Ieg is displayed.

This state is generated when the power output by the engine 10 exceeds an energy sum of power output to the drive wheel 25 and consumed electric power of an auxiliary device such as an air conditioner.

FIG. 10B shows an energy flow image IMEF-6 displayed when the vehicle travels in the series hybrid travel mode and electric power is supplied to the DC link DL from the battery 60. In the energy flow image IMEF-6, the icon Ieg and the icon Ibt are displayed, and the flow object Fo1 directed toward the icon Idw from the icon Ieg and the icon Ibt is displayed. This state is generated when the power output by the engine 10 is lower than an energy sum of power output to the drive wheel 25 and consumed electric power of an auxiliary device such as an air conditioner.

FIG. 10C shows an energy flow image IMEF-7 displayed when the vehicle travels in the series hybrid travel mode and the battery 60 is neither charged nor discharged. In the energy flow image IMEF-7, the icon Ieg is displayed, and the flow object Fo1 directed toward the icon Idw from the icon Ieg is displayed. This state is generated when the power output by the engine 10 coincides with an energy sum of power output to the drive wheel 25 and consumed electric power of an auxiliary device such as an air conditioner.

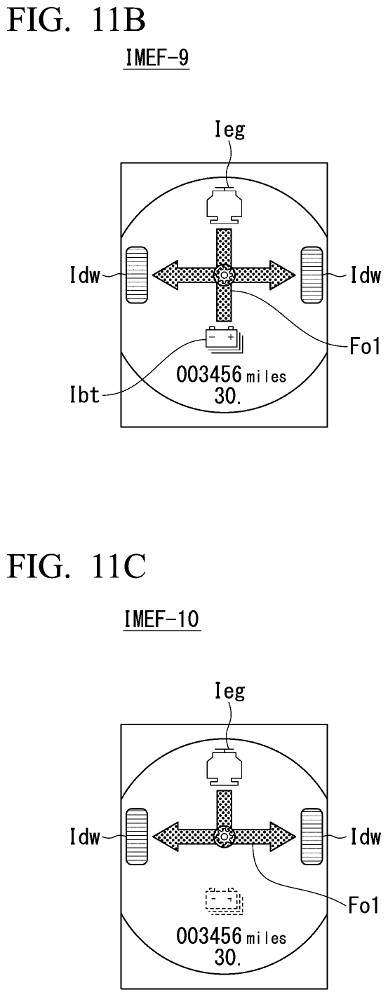

FIG. 11A to 11C are views showing examples of energy flow images IMEF-8 to IMEF-10 displayed when the vehicle travels in the engine drive travel mode. FIG. 11A shows an energy flow image IMEF-8 displayed when the vehicle travels in the engine drive travel mode and the battery 60 is charged. In the energy flow image IMEF-8, the icon Ieg and the icon Ibt are displayed, and the flow object Fo1 directed toward the icon Ibt and the icon Idw from the icon Ieg is displayed. This state is generated when the power output by the engine 10 exceeds an energy sum of power output to the drive wheel 25 and consumed electric power of an auxiliary device such as an air conditioner.

FIG. 11B shows an energy flow image IMEF-9 displayed when the vehicle travels in the engine drive travel mode and electric power is supplied to the DC link DL from the battery 60. In the energy flow image IMEF-9, the icon Ieg and the icon Ibt are displayed, and the flow object Fo1 directed toward the icon Idw from the icon Ieg and the icon Ibt is displayed. This state is generated when the power output by the engine 10 is lower than an energy sum of power output to the drive wheel 25 and consumed electric power of an auxiliary device such as an air conditioner.

FIG. 11C shows an energy flow image IMEF-10 displayed when the vehicle travels in the engine drive travel mode and the battery 60 is neither charged nor discharged. In the energy flow image IMEF-10, the icon Ieg is displayed, and the flow object Fo1 directed toward the icon Idw from the icon Ieg is displayed. This state is generated when the power output by the engine 10 coincides with an energy sum of power output to the drive wheel 25 and consumed electric power of an auxiliary device such as an air conditioner.

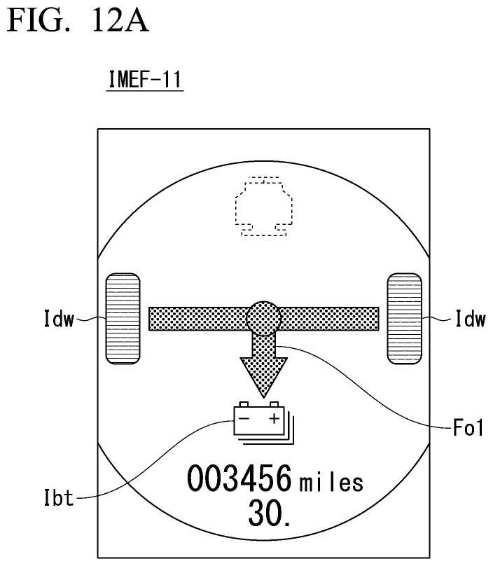

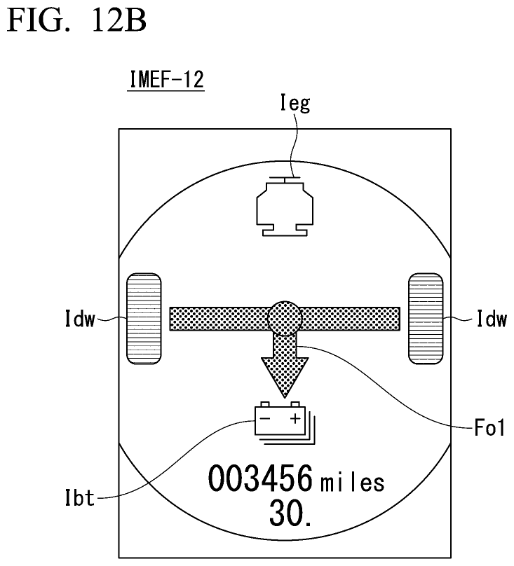

FIG. 12A to 12B are views showing examples of energy flow images IMEF-11 and IMEF-12 displayed when the vehicle decelerates by regeneration. FIG. 12A shows an energy flow image IMEF-11 displayed when regeneration is performed and an operation request of the engine 10 does not occur. In the energy flow image IMEF-11, the icon Ibt is displayed, and a flow object Fo1 directed toward the icon Ibt from the icon Idw is displayed.

FIG. 12B shows an energy flow image IMEF-12 displayed when regeneration is performed and an operation request of the engine 10 occurs. In the energy flow image IMEF-12, the icon Ieg and the icon Ibt are displayed, and the flow object Fo1 directed toward the icon Ibt from the icon Idw is displayed.

The operation request of the engine 10 may be an event occurring inside the control part 50 or may be a command signal given to a control device of the engine 10. In the former case, for example, flag information indicating whether or not the operation request of the engine 10 occurs is written in a predetermined region in a memory of the control part 50 by the hybrid control portion 55, and a process in which the engine control portion 51 refers to the flag information and controls the engine 10 is performed.

The operation request of the engine 10 occurs, for example, in the following cases.

(1) A case in which electric power supplied from the battery 60 is not sufficient for electric power for traveling or for driving an auxiliary device, or the SOC of the battery 60 is too low.

(2) A case in which a temperature of the second motor 18 exceeds a reference temperature.

(3) A case in which a non-operation time of the engine 10 exceeds a reference time.

(4) A case in which it is necessary to cause the engine 10 to operate for periodic self-diagnosis.

Although (1) among the above cases occurs mainly due to an acceleration pedal operation of a driver, (2) to (4) occur due to circumstances on the vehicle side. Therefore, the operation request of the engine 10 may continue regardless of whether the vehicle accelerates or decelerates in some cases.

[Energy Flow Image IMEF in Accordance with Degree of Degradation of Battery 60]

Hereinafter, a process in which the display control portion 126 changes the energy flow image IMEF in accordance with the degree of degradation of the battery 60 is described. First, the display control portion 126 determines the degree of degradation of the battery 60 on the basis of the degradation amount derived by the evaluation portion 124. The display control portion 126 determines, for example, whether or not the degradation amount is equal to or more than a first threshold value. When the degradation amount is less than the first threshold value, the display control portion 126 considers that the degradation of the battery 60 has not progressed and determines that the degree of degradation of the battery 60 is “good”. When it is determined that the degradation amount is equal to or more than the first threshold value, the display control portion 126 determines whether or not the degradation amount is equal to or more than a second threshold value. The first threshold value and the second threshold value have a relationship in which the first threshold value is smaller than the second threshold value. When the degradation amount is equal to or more than the first threshold value and less than the second threshold value, the display control portion 126 considers that the deterioration of the battery 60 progresses to a certain extent and determines that the degree of degradation of the battery 60 is “moderate”. When the degradation amount is equal to or more than the second threshold value, the display control portion 126 considers that the degradation of the battery 60 progresses and determines that the degree of degradation of the battery 60 is “bad”.

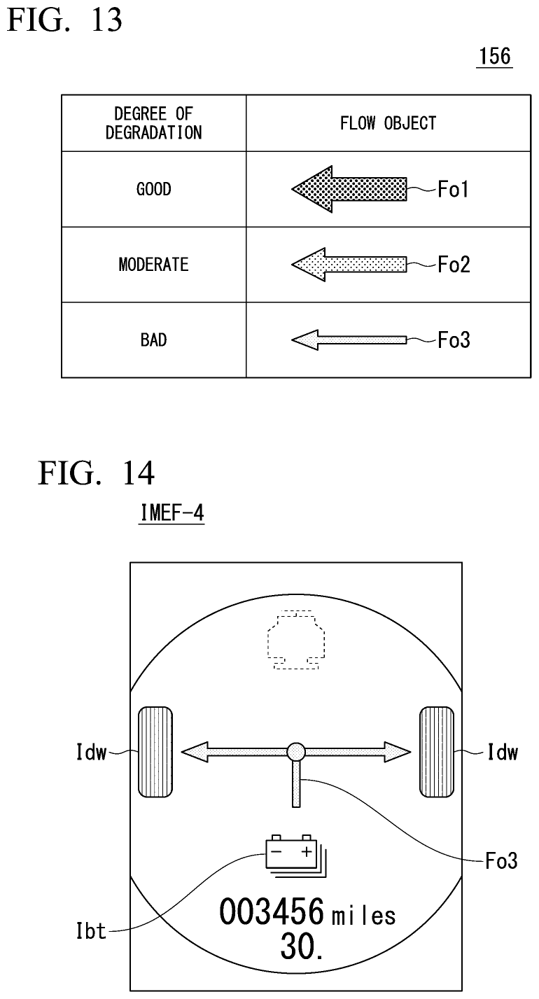

The display control portion 126 selects the flow object Fo included in the energy flow image IMEF on the basis of a determination result of the degree of degradation and the degradation image information 156. FIG. 13 is a view showing an example of contents of the degradation image information 156. The degradation image information 156 is, for example, information in which the degree of degradation of the battery 60 and the flow object Fo are associated with each other. In FIG. 13, the degree of degradation “good” is associated with a flow object Fo1, the degree of degradation “moderate” is associated with a flow object Fo2, and the degree of degradation “bad” is associated with a flow object Fo3.

The flow object Fo1 is, for example, an object which indicates that the charging/discharging of the battery 60 is smooth (for example, the current maximum capacity is large) compared to other flow objects Fo. The flow object Fo2 is, for example, an object which indicates that the charging/discharging is not smoother (for example, the current maximum capacity is small) than the flow object Fo1. The flow object Fo3 is, for example, an object which indicates that the charging/discharging is not smoother than the flow objects Fo1 and Fo2. In FIG. 13, the flow object Fo is indicated by a thick arrow when the charging/discharging is smooth and is indicated by a thin arrow when the charging/discharging is not smooth.

The above embodiment is described using a case in which the flow object Fo indicates the smoothness of charging/discharging by the thickness of the arrow; however, the embodiment is not limited thereto. The flow object Fo may indicate the smoothness of charging/discharging by a display mode other than the thickness of the arrow. For example, the flow object Fo may be an object that indicates the smoothness of charging/discharging by a color, may be an object that indicates the smoothness of charging/discharging by the shape of the arrow, may be an object that indicates the smoothness of charging/discharging by a display mode (blinking, movement, or the like), or may be an object that indicates the smoothness of charging/discharging by a combination of these display modes. The above embodiment is described using a case in which the degree of degradation is indicated by three stages of “good”, “moderate”, and “bad”; however, the embodiment is not limited thereto. The degree of degradation may be indicated by a linear value, and the degradation image information 156 may be one that varies the display mode (for example, varies the thickness, the color, or the like) of the flow object Fo in response to the linear value.

In a situation (that is, situations of the energy flow images IMEF-3 to IMEF-6, IMEF-8 to IMEF-9, and IMEF-11 to IMEF 12) in which the operation (charging/discharging) of the battery 60 is affected in accordance with the degradation of the battery 60 among situations in which the energy flow images IMEF-1 to IMEF-12 are displayed, the display control portion 126 searches the degradation image information 156 using the determination result of the degree of degradation as a search key and selects a flow object Fo included in the energy flow image IMEF. The display control portion 126 generates an energy flow image IMEF including the selected flow object Fo and displays the energy flow image IMEF on the display part 110.

FIG. 14 is a view showing an example of the energy flow image IMEF-4 when the degree of degradation of the battery 60 is “bad”. Hereinafter, a process of the display control portion 126 when the degree of degradation of the battery 60 is “bad” is described using the energy flow image IMEF-4; however, a similar process is also performed with respect to the energy flow image IMEF regarding another situation in which the operation (charging/discharging) of the battery 60 is affected.

The display control portion 126 selects the flow object Fo3 as a flow object Fo indicating that the drive wheel 25 is driven by the electric power supplied by the battery 60 in the EV travel mode in the situation in which the energy flow image IMEF-4 is displayed by the process described above.

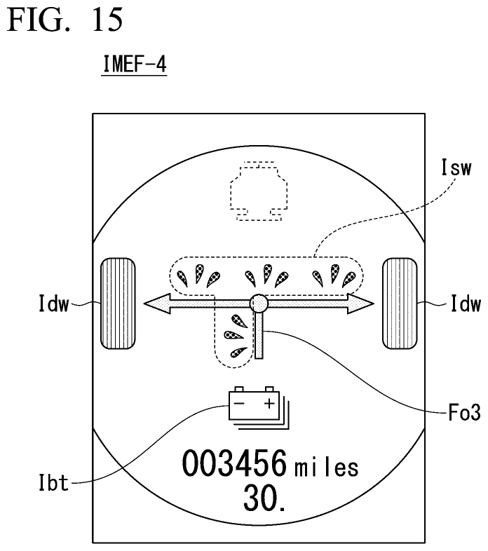

FIG. 15 is a view showing another example of the energy flow image IMEF-4 when the degree of degradation of the battery 60 is “bad”. When it is determined that the degree of degradation of the battery 60 is “bad” by the process described above, the display control portion 126 may include, in the energy flow image IMEF, an image (the icon Isw shown in the drawing) indicating that the degree of degradation of the battery 60 is “bad” in addition to (alternatively, in place of) a configuration in which the display mode of the flow object Fo is changed. In the energy flow image IMEF-4 of FIG. 15, the display control portion 126 arranges an icon Isw of “sweating” around the flow object Fo3 by which the battery 60 appears to work hard to supply electric power to the drive wheel 25.

[Operation Flow]

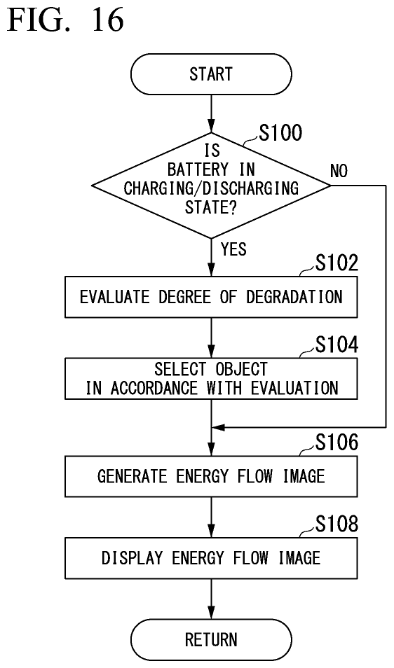

FIG. 16 is a flowchart showing an example of a process of the display control apparatus 100 according to the first embodiment. First, the evaluation portion 124 determines whether or not the travel mode determined by the hybrid control portion 55 is a travel mode involving charging/discharging of the battery 60 (that is, whether the travel mode determined by the hybrid control portion 55 is (1) the EV travel mode (EV), (2) the series hybrid travel mode (ECVT), or (4) the regeneration) (Step S100). When it is determined that the travel mode determined by the hybrid control portion 55 is not a travel mode involving charging/discharging of the battery 60, the evaluation portion 124 advances the process to Step S106.

When it is determined that the travel mode determined by the hybrid control portion 55 is a travel mode involving charging/discharging of the battery 60, the evaluation portion 124 determines the degree of degradation of the battery 60 on the basis of the usage situation information 152 generated by the acquisition portion 122 (Step S102). The evaluation portion 124 calculates the degradation amount of the battery 60 in an evaluation target period and evaluates the degree of degradation of the battery 60. The display control portion 126 selects the flow object Fo in accordance with the degree of degradation of the battery 60 on the basis of the evaluation result of the evaluation portion 124 and the degradation image information 156 (Step S104).

The evaluation portion 124 generates an energy flow image IMEF on the basis of the image information 154 (Step S106). Here, when the flow object Fo is selected in Step S104, the display control portion 126 generates an energy flow image IMEF including the selected flow object Fo. When the mode is a travel mode that does not involve charging/discharging of the battery 60, the display control portion 126 generates the energy flow image IMEF by using the flow object Fo1. The display control portion 126 causes the display part 110 to display the generated energy-flow image IMEF.

### Summary of First Embodiment

As described above, the display control apparatus 100 of the present embodiment can inform the vehicle user that charging/discharging cannot be smoothly performed compared to a case where the battery 60 is not degraded by narrowing the arrow of the flow object Fo3, and it is possible to inform the user that the battery 60 is degraded in a visually easy-to-understand manner. According to the display control apparatus 100 of the present embodiment, by including the icon Isw or the like in the energy flow image IMEF, it is possible to inform the user that charging/discharging cannot be smoothly performed in a further visually easy-to-understand manner compared to the case where the battery 60 is not degraded.

### Modified Example 1

Hereinafter, modified example 1 according to the above first embodiment is described with reference to the drawings. Modified example 1 is described using a case in which the display control portion 126 causes the display part 110 to display the energy flow image IMEF in accordance with the degree of degradation of the battery 60 only in a situation in which the degradation of the battery 60 affects the travel of the vehicle among travel modes involving charging/discharging of the battery 60. A configuration similar to that of the first embodiment described above is given the same reference numerals, and description thereof is omitted.

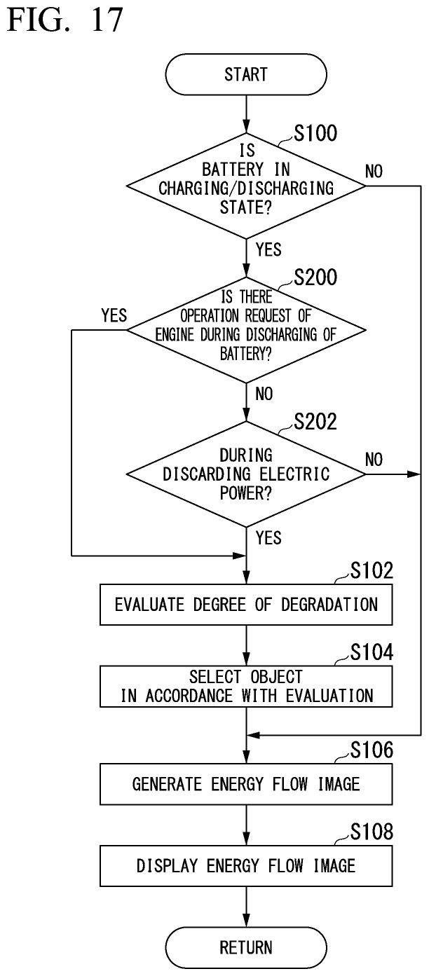

FIG. 17 is a flowchart showing an example of a process of the display control apparatus 100 according to modified example 1. A process identical to the process shown in FIG. 16 among the processes shown in FIG. 17 is given the same step numbers, and description thereof is omitted.

When it is determined that the travel mode determined by the hybrid control portion 55 is a travel mode involving charging/discharging of the battery 60, the evaluation portion 124 of modified example 1 determines whether or not the situation is a situation in which the degradation of the battery 60 affects the travel of the vehicle. Specifically, the evaluation portion 124 determines whether or not the battery is being discharged and there is an operation request of the engine 10 by the control part 50 (Step S200). When it is determined that the situation is not a situation in which there is an operation request of the engine 10 by the control part 50 during the discharging of the battery 60, the evaluation portion 124 determines whether or not the generated electric power by regeneration is being discarded (that is, the situation is a situation in which the generated electric power associated with regeneration cannot be charged to the battery 60) (Step S202).

When it is determined by the evaluation portion 124 that there is an operation request of the engine 10 by the control part 50 during the discharging of the battery 60, or it is determined by the evaluation portion 124 that the generated electric power by regeneration is being discarded, the display control portion 126 considers that it is necessary to change the energy flow image IMEF in accordance with the degree of degradation of the battery 60 and advances the process to Step S102. When it is determined by the evaluation portion 124 that there is not an operation request of the engine 10 by the control part 50 during the discharging of the battery 60, and it is determined by the evaluation portion 124 that the generated electric power by regeneration is not being discarded, the display control portion 126 considers that it is not necessary to change the energy flow image IMEF in accordance with the degree of degradation of the battery 60 and advances the process to Step S106.

### Summary of Modification Example 1

Here, when the degradation of the battery 60 progresses, in a situation (for example, (1) a situation when the operation request of the engine is performed in which electric power supplied from the battery 60 is not sufficient for the electric power for traveling or for driving an auxiliary device, or the SOC of the battery 60 is too low) where the degradation of the battery 60 affects the travel of the vehicle, there is a case in which it may be required to increase the accelerator opening or increase the brake pedal amount because the discharging electric power of the battery 60 is not sufficient at an earlier timing compared to the time of shipping. According to the display control apparatus 100 of modified example 1, in a situation where the degradation of the battery 60 affects the travel of the vehicle rather than a timing when the battery 60 is simply charged or discharged, by informing the user that the battery 60 is degraded in a visually easy-to-understand manner, it is possible to effectively inform the user of such information.

### Modified Example 2

Hereinafter, modified example 2 according to the above first embodiment is described with reference to the drawings. Modified example 2 is described using a case in which the display control portion 126 causes the display part 110 to display the energy flow image IMEF in accordance with the estimated degree of degradation of the future battery. A configuration similar to that of the first embodiment and modified example 1 described above is given the same reference numerals, and description thereof is omitted.

The evaluation portion 124 of modified example 2 further evaluates the degree of degradation of the future battery 60. The evaluation portion 124 calculates a degradation amount to date, for example, on the basis of the usage situation information 152 in an evaluation target period and estimates the degree of degradation of the future battery 60 on the basis of the calculated degradation amount and the length of the evaluation target period. The evaluation portion 124 may acquire the degradation amount of the future battery 60 by using a learning model learned such that the calculated degradation amount and the evaluation target period are input and the degradation amount of the future battery 60 is output and thereby estimate the degradation amount of the future battery 60.

The evaluation portion 124 may estimate the degradation amount of the future battery 60 on the basis of table data in which the calculated degradation amount, the evaluation target period, and the degradation amount of the future battery 60 are associated with one another. The term “future” refers to, for example, a time (timing) after a predetermined period (for example, several weeks, several months, several years, and the like) from the present.

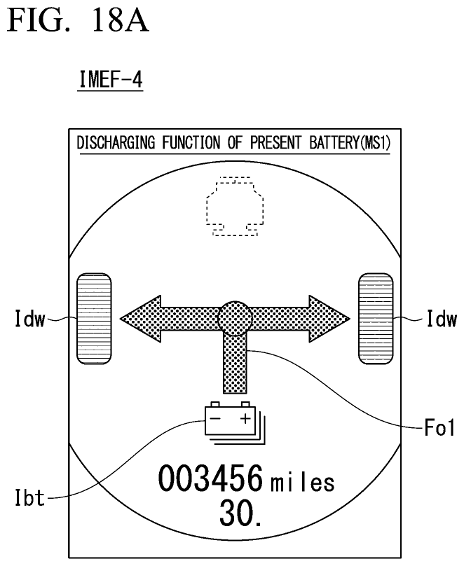

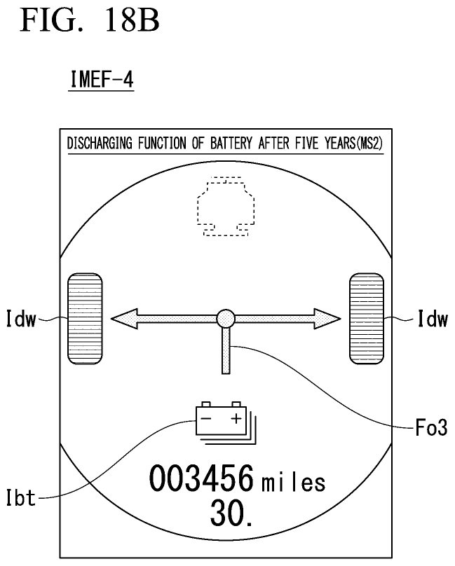

The display control portion 126 of modified example 2 generates an energy flow image IMEF on the basis of the degradation amount of the future battery 60 calculated by the evaluation portion 124 and displays the energy flow image IMEF on the display part 110. FIGS. 18A to 18B are views showing an example of an energy flow image IMEF-4 according to modified example 2. FIG. 18A shows a discharging function to the drive wheel 25 from the battery 60 of the present degree of degradation. FIG. 18B shows a discharging function to the drive wheel 25 from the battery 60 of the estimated future (in the drawing, five years later) degree of degradation. A message MS1 indicating that the information relates to the battery 60 of the present degree of degradation is included in the energy flow image IMEF-4 of FIG. 18A. A message MS2 indicating that the information relates to the battery 60 of the future degree of degradation is included in the energy flow image IMEF-4 of FIG. 18B.

The display control portion 126 displays, for example, FIG. 18A and FIG. 18B alternately on the display part 110. Thereby, the display control portion 126 of modified example 2 can inform the vehicle user of the degree of degradation of the future battery 60 in advance.

[Display of Energy Flow Image IMEF Based on User's Command]

The above embodiment is described using a case in which the display control portion 126 changes the energy flow image IMEF in accordance with the degree of degradation of the battery 60 evaluated by the evaluation portion 124; however, the embodiment is not limited thereto. The display control portion 126 may not change the energy flow image IMEF in accordance with the degree of degradation of the battery 60 in response to a user's command and may generate the energy flow image IMEF assuming that the battery 60 is degraded in advance. In this case, the user's command of the user is received by a HMI (Human Machine Interface) (not shown) included in the vehicle, and the display control portion 126 generates the energy flow image IMEF on the basis of the received user's command Here, there are cases in which a vehicle user may not want to acquire information relating to the degradation of the battery 60. In this case, according to the process of the display control portion 126 described above, it is possible to prevent the information regarding the degradation of the battery 60 from being presented to the vehicle user.

The vehicle may be driven assuming that the battery 60 is degraded in advance without changing the energy flow image IMEF in accordance with the degree of degradation of the battery 60 in response to the user's command. In this case, when the user's command received by the HMI included in the vehicle is a command for driving the vehicle assuming that the battery 60 is degraded in advance, the control part 50 controls the charging/discharging of the battery 60 assuming that the capacity of the battery 60 is lower by a predetermined capacity than the full-charge capacity of the battery 60 at the time of shipping regardless of the present maximum capacity of the battery 60. The capacity that is lower by the predetermined capacity than the full-charge capacity of the battery 60 at the time of shipping is, for example, an estimated value of the full-charge capacity of the battery 60 after a predetermined period of time (several weeks, several months, several years, and the like) elapses. Thereby, the control part 50 can control the vehicle assuming that the battery 60 is degraded in advance and can prevent the vehicle user from perceiving a change in the behavior of the vehicle regarding the degradation of the battery 60.

[Energy Flow Image IMEF in Response to High Efficiency Driving]

The display control portion 126 may change the energy flow image IMEF in response to high-efficiency driving being performed in addition to the process in which the energy flow image IMEF is changed in accordance with the degree of degradation of the battery 60. High-efficiency driving is, for example, driving in which unnecessary acceleration operation is not performed when only the electric power supplied from the battery 60 can provide electric power for traveling or for driving an auxiliary device in a starting/acceleration phase, a low-to-medium-speed stationary travel phase, an acceleration phase, or the like. Further, high-efficiency driving is, for example, driving in which an unnecessary braking operation is not performed when the deceleration by regenerative braking is sufficient, and the battery 60 can be charged without discarding the electric power generated by the second motor 18 in accordance with regeneration in a deceleration phase. When the control part 50 detects that such driving is performed, the display control portion 126 may include an image indicating that the driving is high-efficiency driving in the energy flow image IMEF.

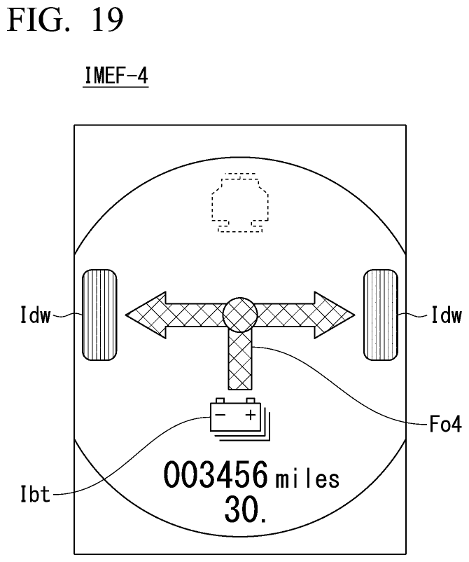

FIG. 19 is a view showing an example of an energy flow image IMEF-4 when high-efficiency driving is performed. The display control portion 126 selects a flow object Fo4 as the flow object Fo indicating that the drive wheel 25 is driven by the electric power supplied by the battery 60 in the EV travel mode when high-efficiency driving is performed in a situation where the energy flow image IMEF-4 is displayed. The flow object Fo4 is an object indicating that the charging/discharging is efficient. Thereby, the display control portion 126 can inform the user that high-efficiency driving is performed in a visually easy-to-understand manner.

### Second Embodiment

Hereinafter, a second embodiment is described with reference to the drawings. The first embodiment and modified examples are described using a case in which information regarding the degradation of the battery 60 is provided to the user. The second embodiment is described using a case in which information regarding degradation of a FC (Fuel Cell) system is provided to the user. A configuration similar to that of the embodiment and modified examples described above is given the same reference numerals, and description thereof is omitted.

[Overall Configuration]

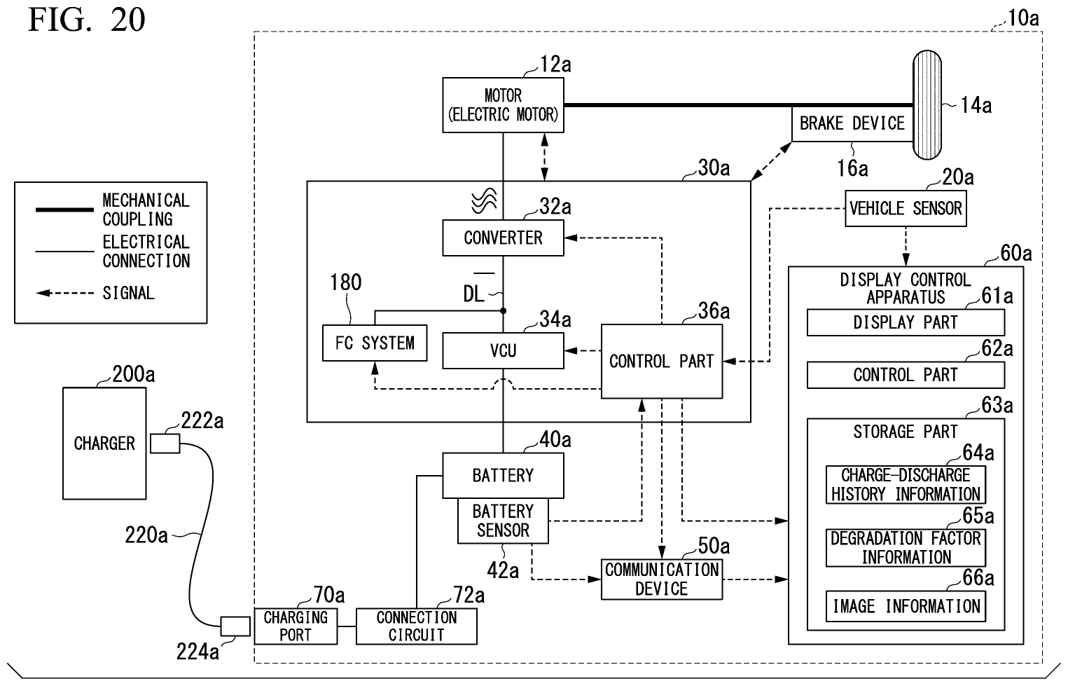

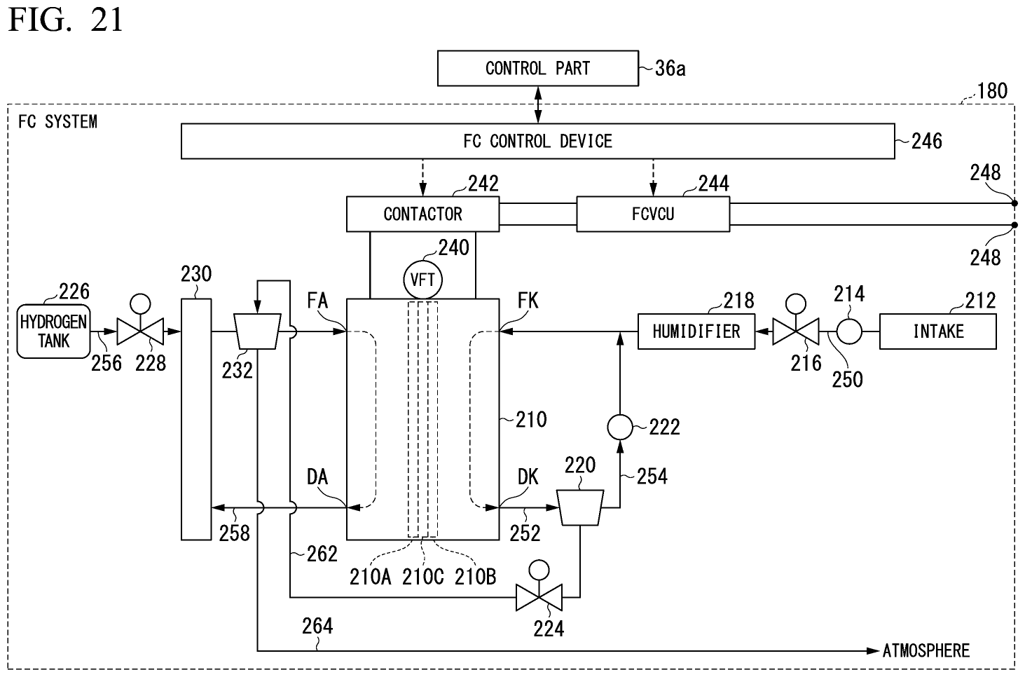

FIG. 20 is a view showing an example of a configuration of a vehicle 10a that includes a display control apparatus 60a according to the second embodiment. As shown in FIG. 20, the vehicle 10a according to the second embodiment includes a FC system 180 in addition to (alternatively, in place of the battery 60) the configuration provided on the vehicle according to the first embodiment. The vehicle 10a includes a control part 36a in place of (alternatively, in addition to) the control part 50.

[FC System 180]

FIG. 21 is a view showing an example of a configuration of the FC system 180 according to the second embodiment. As shown in FIG. 21, the FC system 180 includes, for example, a FC stack 210, an intake 212, an air pump 214, a seal inlet valve 216, a humidifier 218, a gas-liquid separator 220, an exhaust recirculation pump 222, a drain valve 224, a hydrogen tank 226, a hydrogen supply valve 228, a hydrogen circulation part 230, a gas-liquid separator 232, a temperature sensor 240, a contactor 242, a FCVCU (Fuel Cell Voltage Control Unit) 244, an FC control device 246, an output terminal 248, an oxidizer gas supply passage 250, an oxidizer gas discharge passage 252, a fuel gas supply passage 256, a fuel gas discharge passage 258, a connection passage 262, and a drain pipe 264.

The FC stack 210 includes a laminate body (not shown) in which a plurality of cells of a fuel cell are laminated and a pair of end plates (not shown) that sandwich the laminate body from both sides in a lamination direction. The cells of the fuel cell include a membrane electrode assembly (MEA) and a pair of separators that sandwich the membrane electrode assembly from both sides in a junction direction. The membrane electrode assembly includes an anode 210A consisting of an anode catalyst and a gas diffusion layer, a cathode 210B consisting of a cathode catalyst and a gas diffusion layer, and a solid polymer electrolyte membrane 210C consisting of a cation exchange membrane sandwiched from both sides in the thickness direction by the anode 210A and the cathode 210B and the like.

A fuel gas including hydrogen delivered from the hydrogen tank 226 to the fuel gas supply passage 256 and a fuel gas circulated in the hydrogen circulation part 230 are supplied to the anode 210A. Air, which is an oxidizer gas (reaction gas), including oxygen as an oxidizer is supplied to the cathode 210B from the air pump 214. The hydrogen supplied to the anode 210A is ionized on an anode catalyst by a catalytic reaction, and hydrogen ions move to the cathode 210B via a moderately humidified solid polymer electrolyte membrane 210C. Electrons generated in accordance with the movement of the hydrogen ions can be removed to an external circuit (the FCVCU 244 or the like) as a direct current. The hydrogen ions that move from the anode 210A onto the cathode catalyst of the cathode 210B react with the oxygen supplied to the cathode 210B and electrons on the cathode catalyst and generate water.

The air pump 214 includes a motor that is controlled and driven by the FC control device 246 and the like.

The air pump 214 takes in and compresses air from the outside via the intake 212 by a driving force of the motor and feeds the compressed air to the oxidizer gas supply passage 250 connected to the cathode 210B.

The seal inlet valve 216 is provided on the oxidizer gas supply passage 250 that connects the air pump 214 to a cathode supply port FA which supplies air to the cathode 210B of the FC stack 210. The seal inlet valve 216 is opened and closed by a control of the FC control device 246.

The humidifier 218 humidifies the air delivered from the air pump 214 to the oxidizer gas supply passage 250. More specifically, the humidifier 218 includes, for example, a water-permeable membrane such as a hollow fiber membrane. The humidifier 218 adds moisture to the air by contacting the air from the air pump 214 through the water-permeable membrane.

The gas-liquid separator 220 separates the cathode exhaust gas that is not consumed by the cathode 210B and that is discharged from a cathode discharge port DK to the oxidizer gas discharge passage 252 into liquid water and the cathode exhaust gas. The cathode exhaust gas separated from the liquid water by the gas-liquid separator 220 flows into an exhaust recirculation passage 254.

The exhaust recirculation pump 222 is provided on the exhaust recirculation passage 254. The exhaust recirculation pump 222 mixes the cathode exhaust gas that flows from the gas-liquid separator 220 into the exhaust recirculation passage 254 with air that flows through the oxidizer gas supply passage 250 from the seal inlet valve 216 toward the cathode supply port FA and supplies again the cathode exhaust gas mixed with the air to the cathode 210B.

The liquid water separated from the cathode exhaust gas by the gas-liquid separator 220 is discharged through the connection passage 262 to the gas-liquid separator 232 provided on the fuel gas supply passage 256. The liquid water discharged to the gas-liquid separator 232 is discharged to the atmosphere via the drain pipe 264.

The hydrogen tank 226 stores hydrogen in a compressed state.

The hydrogen supply valve 228 is provided on the fuel gas supply passage 256 that connects the hydrogen tank 226 to an anode supply port FK that supplies hydrogen to the anode 210A of the FC stack 210. In a case where the hydrogen supply valve 228 is opened by a control of the FC control device 246, the hydrogen stored in the hydrogen tank 226 is supplied to the fuel gas supply passage 256.

The hydrogen circulation part 230 circulates, in the fuel gas supply passage 256, an anode exhaust gas that is not consumed by the anode 210A and that is exhausted from an anode discharge port DA to the fuel gas discharge passage 258.

The gas-liquid separator 232 separates the anode exhaust gas that circulates in the fuel gas supply passage 256 from the fuel gas discharge passage 258 into liquid water and the anode exhaust gas by an action of the hydrogen circulation part 230. The gas-liquid separator 232 supplies the anode exhaust gas separated from the liquid water to an anode supply port FK of the FC stack 210.

The temperature sensor 240 detects temperatures of the anode 210A and the cathode 210B of the FC stack 210 and outputs a detection signal to the FC control device 246.

The contactor 242 is provided between the FCVCU 244, and the anode 210A and the cathode 210B of the FC stack 210. The contactor 242 electrically connects the FC stack 210 to the FCVCU 244 or cuts off the connection between the FC stack 210 and the FCVCU 244 on the basis of a control from the FC control device 246.

The FCVCU 244 is, for example, a boost-type DC-DC converter. The FCVCU 244 is arranged between an electric load, and the anode 210A and the cathode 210B of the FC stack 210 via the contactor 242. The FCVCU 244 increases a voltage of the output terminal 248 connected to the electric load side to a target voltage determined by the FC control device 246. The FCVCU 244, for example, increases the voltage output from the FC stack 210 to the target voltage and outputs the voltage to the output terminal 248.

In a case where an electric power control part 56 determines that a warm-up of the FC system 180 is required and that a FC requirement electric power required by the FC system 180 is equal to or more than a predetermined value, the FC control device 246 performs a warm-up control of the FC system 180. The electric power control part 56, for example, acquires a detection signal by the temperature sensor 240 from the FC control device 246 and determines that the warm-up of the FC system 180 is required in a case where the temperature of the FC stack 210 detected by the temperature sensor 240 is less than a temperature threshold. The electric power control part 56 acquires the detection signal by the temperature sensor 240 from the FC control device 246 whilst the warm-up control of the FC system 180 is being performed and determines that the warm-up control of the FC system 180 is completed in a case where the temperature of the FC stack 210 detected by the temperature sensor 240 becomes equal to or more than the temperature threshold.

The control part 36a of the present embodiment estimates a degradation degree of the FC system 180 and further learns a degradation state of the FC system 180. For example, the control part 36a derives an electric power generation amount (hereinafter, referred to as a “current maximum electric power generation amount”) of the FC system 180 per a predetermined amount of fuel gas. The control part 36a derives a maximum electric power generation amount ratio of the current maximum electric power generation amount relative to an initial maximum electric power generation amount on the basis of the current maximum electric power generation amount and the initial maximum electric power generation amount. The maximum electric power generation amount ratio is an example of information indicating the degradation state of the FC system 180. The initial maximum electric power generation amount is an amount of electric power generated by the FC system 180 at the time of shipping using a predetermined amount of fuel gas. The control part 36a outputs a derived result to the display control apparatus 60a.

The acquisition portion 62A of the present embodiment acquires information (for example, information indicating a degradation state of the FC system 180) regarding the FC system 180 acquired by the control part 36a from the control part 36a continuously or at a predetermined time interval. The acquisition portion 62A of the present embodiment generates a record of the charge-discharge history information 64a on the basis of the acquired information and generates (updates) the charge-discharge history information 64a.

The charge-discharge history information 64a of the present embodiment is, for example, information including one or more records in which information indicating a current maximum electric power generation amount and information indicating an acquisition date and time at which the current maximum electric power generation amount is acquired are associated with each other.

The evaluation portion 62B of the present embodiment evaluates a degradation amount of the battery 40a on the basis of the charge-discharge history information 64a. The evaluation portion 62B extracts, for example, records in an evaluation target period (for example, one day) of the charge-discharge history information 64a. Then, the evaluation portion 62B compares a current maximum electric power generation amount of the newest record with a current maximum electric power generation amount of the oldest record among the extracted records and derives a degradation amount at which the battery 40a degrades in the evaluation target period. The degradation amount is, for example, a capacity obtained by subtracting the current maximum electric power generation amount of the newest record from the current maximum electric power generation amount of the oldest record. Since subsequent processes are similar to the processes of the embodiment and modified examples described above, description thereof is omitted.

Here, in the FC system 180, there may be cases in which, by repeating electric power generation, the catalytic metal crystallizes, and the electric power generation amount of the FC system 180 per a predetermined amount of fuel gas becomes small (that is, the FC system 180 is degraded). The display control apparatus 60a of the present embodiment can provide detailed information regarding the state change (in this case, degradation) of the FC system 180 as an image that is visually understandable by a user.

Although embodiments of the present invention have been described with reference to the drawings, the present invention is not limited to such embodiments, and various modifications and substitutions can be made without departing from the scope of the invention.

What is claimed is:

1. A display control apparatus, comprising:
an acquisition part that acquires usage situation information of a battery which stores electric power for traveling of a vehicle;
an evaluation part that evaluates a degree of degradation of the battery based on the usage situation information acquired by the acquisition part; and
a display control part that allows a display part to display an image indicating a flow of energy in the vehicle,
wherein the display control part allows the display part to display the image based on an evaluation result of the evaluation part.

2. The display control apparatus according to claim 1,
wherein the evaluation part further evaluates a degree of degradation of the future battery based on the usage situation information, and
the display control part allows the display part to display the image based on an evaluation result of the future battery evaluated by the evaluation part.

3. The display control apparatus according to claim 1,
wherein the display control part allows the display part to display the image in a situation in which a behavior of the vehicle is affected by the degradation of the battery.

4. A display control method, comprising:
by way of a computer,
acquiring usage situation information of a battery which stores electric power for traveling of a vehicle;
evaluating a degree of degradation of the battery based on the acquired usage situation information;
displaying, on a display part, an image indicating a flow of energy in the vehicle; and
displaying, on the display part, the image based on an evaluation result.

5. A computer-readable non-transitory storage medium that includes a program causing a computer to:
acquire usage situation information of a battery which stores electric power for traveling of a vehicle;
evaluate a degree of degradation of the battery based on the acquired usage situation information;
display, on a display part, an image indicating a flow of energy in the vehicle; and
display, on the display part, the image based on an evaluation result.

6. The display control apparatus according to claim 2,
wherein the display control part allows the display part to display the image in a situation in which a behavior of the vehicle is affected by the degradation of the battery.
